(19) United States
(12) Patent Application Publication
(10) Pub. No.: US 2012/0247223 A1
(43) Pub. Date: Oct. 4, 2012

(54) Electroless Plated Fluid Flow Conditioner and Pipe Assembly

(75) Inventors: Daniel A. Sawchuk, Chestermere (CA); Blaine D. Sawchuk, De Winton (CA); Dale P. Sawchuk, Calgary (CA); Reginald Selirio, Calgary (CA)

(73) Assignee: Canada Pipeline Accessories, Co. Ltd., Calgary (CA)

(21) Appl. No.: 13/407,810

(22) Filed: Feb. 29, 2012

Related U.S. Application Data
(60) Provisional application No. 61/469,212, filed on Mar. 30, 2011.

(51) Int. Cl. G01F 1/00; B05D 3/02; G01F 1/42

(52) U.S. Cl. 73/861; 138/44; 427/229

(57) ABSTRACT

A method and system for electroless nickel plating of fluid flow measurement components used in oil and gas pipelines provides uniformly and consistently plating of all surfaces of the fluid flow components, including flow conditioners, with an electroless nickel plating that imparts the component with desirable characteristics related to hardness, smoothness, wear and abrasion resistance, and corrosion and oxidation resistance, such that the build up of contaminant deposits on the component is reduced and repeatable and accurately fluid flow measurements can be made.

The U.S. nonprovisional application claims priority of provisional application No. 61/469,212 filed on Mar. 30, 2011 in the U.S. Patent and Trademark Office, the entirety of which is incorporated by reference herein.

### I. FIELD OF THE INVENTION

The present invention relates to fluid flow measurement components used in oil and gas pipelines. More particularly, the present invention relates to a system and method for uniformly and consistently coating a fluid flow conditioner with an electroless nickel plating that reduces the build up of deposits on the flow conditioner.

### II. BACKGROUND OF THE INVENTION

Pipelines are used to transport fluids in various industries, including chemical, oil and gas, and manufacturing. These industries use processes that require fluid flow rates to be accurately measured. These measurements are performed at locations known as meter stations using a variety of different meter types. These meters function in different ways, they can use: differential pressure of the fluid across an obstruction, ultrasonic signal travel times, turbine blade rotational speed, Coriolis forces, or even electrical and magnetic fields being generated due to bulk fluid movement. Almost all of these measurement methods require use of the fluid velocity distribution, known as a velocity flow profile.

To achieve the most accurate measurements, the flow profile of the fluid entering a metering device must be stable, non-rotating, and symmetric. This type of velocity distribution is known as a fully developed flow profile, and it forms naturally in very long lengths of uninterrupted straight pipe. However, having long lengths of straight pipe is impractical and cost prohibitive. As a result, meter station piping often contains elbows, tees, valves and other assemblies that distort the flow profile into an asymmetric, unstable, and distorted configuration. This makes it very difficult to measure the fluid flow rate in a consistently accurate and repeatable manner. Under these conditions, flow conditioners are needed to correct the flow profile of the fluid such that it forms a fully developed flow profile which allows accurate, repeatable measurements to be made.

Several types of flow conditioners exist, including straightening vanes, tube bundles, and perforated plates. These flow conditioners are placed within the pipe upstream of the flow meter. A typical perforated plate flow conditioner consists of a perforated metal plate that is arranged within a pipe orthogonal to the fluid flow, i.e., across the entire cross section of pipe. The perforations or holes in the flow conditioner cause the fluid flow to be redistributed such that it forms a fully developed flow profile. The placement of a flow conditioner upstream of the flow meter ensures that the flow is fully developed before it reaches the meter. This allows the meter to perform significantly more accurate and repeatable fluid flow measurements.

Flow conditioners are effective in eliminating bulk rotation and correcting asymmetric flow profiles that can lead to inaccurate flow meter readings. However, other sources of inaccuracy can exist within typical fluid flow pipes including those with flow conditioners installed. Fluid flow measurement systems have been found to exhibit appreciable degradation in system accuracy over time. This degradation in system accuracy is usually attributed to be a result of the buildup of deposits from the fluid onto the flow conditioner, pipe, meter, and other system components. Deposits on the surface of pipe components can alter the geometry of the components, thus changing the flow profile, and contributing to meter error.

Traditionally, carbon steel piping components are used with no plating or a basic layer of paint or primer. This exposes the piping and its components to significant corrosion (chemical reactions between the fluid and the pipe component). Due to the corrosion, typical carbon steel piping components tend to decay, i.e., rust, collect build up, flake, and/or peel—which changes the internal geometry and surface properties of the pipe, resulting in significant flow meter error.

Further, these systems are often used in the chemical and oil and gas industries to transport fluids that may include a variety of suspended contaminant materials such as dirt, sand, rocks, salts, etc. These contaminants can erode (physically wear down over time) surfaces in a pipeline or cause physical damage through impacts, resulting in changes to the fluid pipe wall friction and significant distortions in the velocity flow profile. As a result, these systems have required frequent cleaning or replacement of the measurement system and/or large sections of the pipe in order to maintain the accuracy of the system. Particularly, the section of pipe upstream of the flow meter is critical to system accuracy and therefore, requires frequent cleaning.

Maintenance and repair of pipelines is extremely costly and labor intensive. Often pipelines are located in remote and austere environments that are difficult to access. Sometimes pipelines are submerged below the ocean or buried on land. Accordingly, it is desirable to minimize the need for maintenance and repair.

An example of a known flow conditioner 100 is illustrated in FIGS. 1A-1B. Flow conditioner 100 comprises a circular plate having an array of axially aligned apertures 110 formed therein. The apertures in known flow conditioners are typically sized and arranged to have a specific effect on the profile of the fluid flow. Flow conditioners are typically designed to create swirl-free flow at a certain cross-sectional flow position, e.g., a metering point located at the end of a long length of straight pipe. The length of the long straight section of pipe is accepted within the art as being a multiple of the pipe inside diameter, the exact number of which may be dependent on the particular flow conditioner used. Therefore, the flow conditioner 100 is placed in a section of pipe that is several pipe diameters upstream of a fluid flow measurement device or flow meter. This placement allows the flow conditioner to normalize or affect the fluid flow such that more accurate measurements can be made at the meter site.

FIGS. 1C-1D illustrate an example of a known flow conditioner 100 after a period of use in a flow measurement system. Over time, contaminant materials 150 deposit and build up on the surface of the flow conditioner 100 and pipe (not shown). The contaminant materials 150 may also obstruct or block the apertures 110 such that the fluid does not evenly pass through all the apertures 110.

FIG. 1E illustrates an example of a meter tube that includes an example of a known flow conditioner 100. The flow measurement system includes a plurality of fluid flow measurement system components present along a meter run including a flow conditioner 100 having apertures 110, a section of pipe of a length determined by the meter run, and a fluid flow measurement device 130. The flow conditioner 100 is disposed across the internal cross-section of pipe 120 between length of pipe UL1 and UL2. The flow conditioner 100 is arranged upstream of a fluid flow measurement device 130.

The installation distance of the flow conditioner is dependent on the model being used and the research backing up the flow conditioner performance. It is usually independent of the piping application as a good performing flow conditioner is designed to perform the same regardless of the scenario it is installed into. The positioning itself is determined through detailed testing as described in the various flow measurement standards (AGA3, AGA9, ISO5167). Material 150 within the fluid flow collects on the fluid flow measurement system components including flow conditioner 100 and pipe 120. The buildup of material 150 creates turbulence in the fluid flow and changes in the flow cross sectional area that cause the fluid flow measurement device 130 to make inaccurate and/or unrepeatable measurements.

### III. SUMMARY OF THE INVENTION

The present invention, in at least one embodiment, provides a flow conditioner including a disk having a flange; an array of apertures formed in the disk, the apertures being sized and arranged to generate a specific flow profile in a fluid flow when placed within a fluid flow pipe in an orientation substantially perpendicular to the axis of the conduit; and an electroless nickel plating deposited on the surface of the disk, wherein the plating is uniformly applied to cover the entire surface of the device including the walls of the apertures.

The present invention, in at least another embodiment, provides a pipe assembly for flow measurement including a fluid flow pipe; a flow conditioner disposed within the fluid flow pipe in an orientation substantially perpendicular to an axis of the fluid flow pipe, including a disk having a flange; an array of apertures formed in the disk, the apertures being sized and arranged to generate a specific flow profile in a fluid flow; and an electroless nickel plating deposited on the surface of the disk, wherein the plating is uniformly applied to cover the entire surface of the device including the walls of the apertures.

The present invention, in yet another embodiment, provides a fluid flow measurement system including a fluid flow pipe; a flow conditioner disposed within the fluid flow pipe in an orientation substantially perpendicular to an axis of the fluid flow pipe, including a disk having a flange; an array of apertures formed in the disk, the apertures being sized and arranged to generate a specific flow profile in a fluid flow; and an electroless nickel plating deposited on the surface of the disk, wherein the plating is uniformly applied to cover the entire surface of the disk including the walls of the apertures; and a fluid flow meter in communication with the pipe.

An object of the present invention is to provide a flow measurement system having excellent resistance to wear and abrasion.

An object of the present invention is to provide a flow conditioner having excellent resistance to wear and abrasion.

Another object of the present invention is to provide a flow conditioner having excellent resistance to alkali corrosion and oxidation.

Another object of the present invention is to provide a flow conditioner having a fully plated, uniform surface, including holes, apertures, grooves, and other intricate shapes.

An advantage of the present invention is the prevention of material buildup on the surface of flow conditioners and piping components.

Another advantage of the present invention is improving the accuracy of fluid flow measurement systems by avoiding errors due to distorted flow caused by contaminant buildup.

Another advantage of the present invention is avoiding the necessity to frequently clean or replace fluid flow measurement components, including flow conditioners, flow meters, and sections of pipe, due to diminished meter accuracy or repeatability caused by contaminant buildup.

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

### IV. BRIEF DESCRIPTION OF THE DRAWINGS

FIG. 1A illustrates an example of a prior art flow conditioner.

FIG. 1B illustrates a side view of the prior art flow conditioner as illustrated in FIG. 1A.

FIG. 1C illustrates a prior art flow conditioner after a period of use.

FIG. 1D illustrates a side view of the prior art flow conditioner as illustrated in FIG. 1C.

FIG. 1E illustrates an example of a flow measurement system that includes a prior art flow conditioner.

FIG. 2 outlines a brief overview of the electroless plating process of the present invention.

FIG. 3A illustrates an example of an embodiment of a flow conditioner in accordance with the present invention.

FIG. 3B illustrates a side view of the embodiment of the present invention as illustrated in FIG. 3A.

FIG. 3C illustrates a flow measurement system including a flow conditioner in accordance with the present invention.

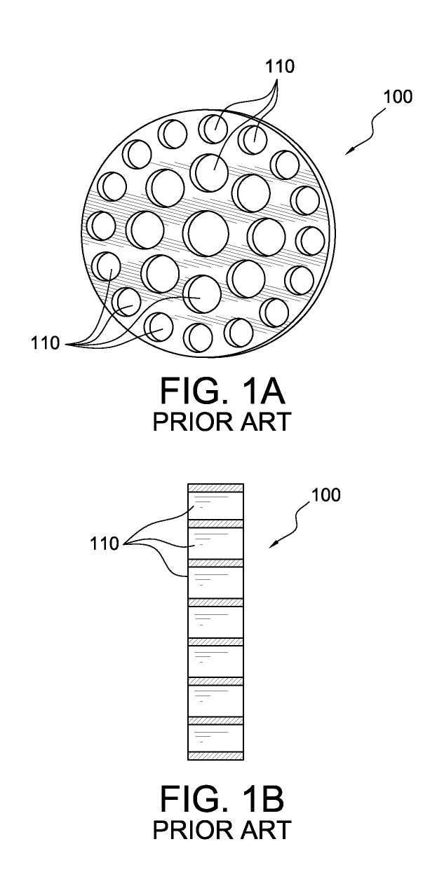

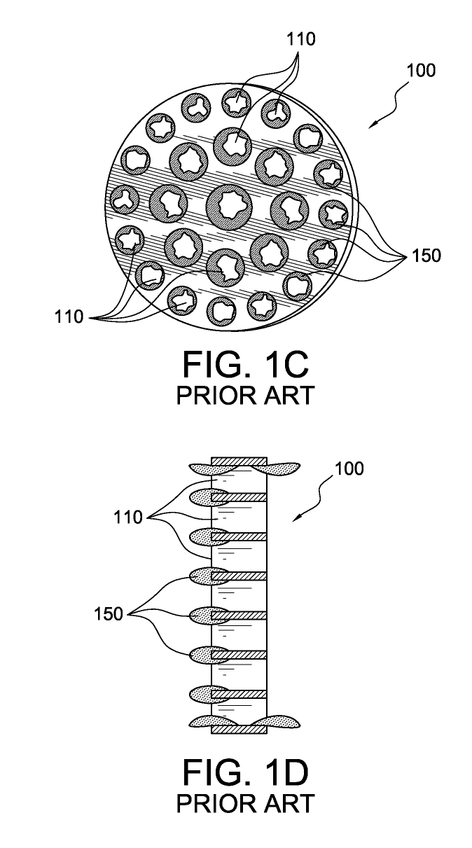

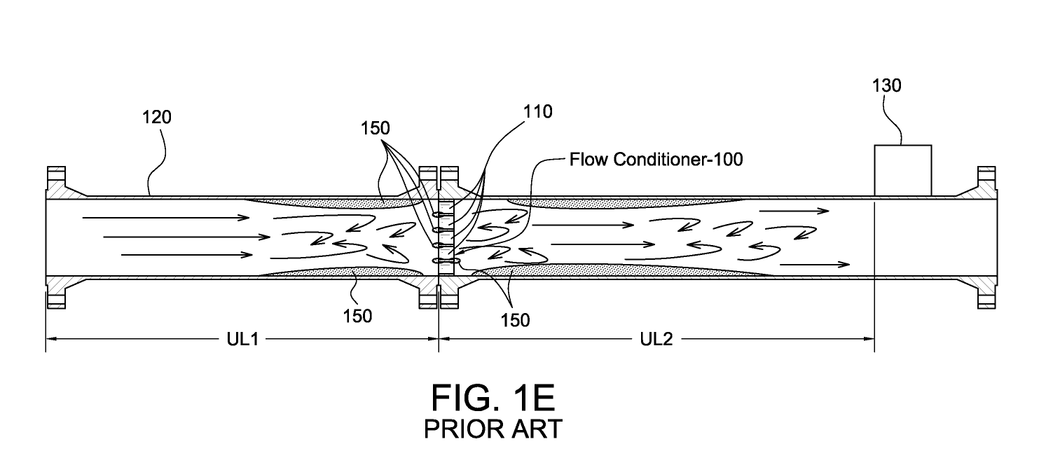

Given the following enabling description of the drawings, the methods and systems should become evident to a person of ordinary skill in the art.

### V. DETAILED DESCRIPTION OF THE INVENTION

The present invention provides an electroless nickel (EN) plated fluid flow measurement system including an electroless nickel plated fluid flow conditioner. The electroless nickel plated fluid flow measurement system may also include one or more sections of electroless nickel plated pipe wherein the fluid flow conditioner is disposed within the one or more sections of pipe. Nickel based plating is applied to the fluid flow conditioner by an electroless plating process. The electroless nickel plating enhances the corrosion and wear resistance of the flow conditioner, thereby reducing deposit buildup on the flow conditioner, which improves the accuracy and performance of the flow measurement system.

The present invention provides several advantages over known fluid flow measurement systems. These advantages include improved corrosion resistance, increased contaminant repulsion, increased surface hardness, increased surface smoothness, improved plating uniformity, and improved plating density, in addition to maintaining the pretreatment surface finish. Many modern fluid flow meters, particularly ultrasonic flow meters, are sensitive to internal fluid flow changes, including those caused by deposit buildup. The present invention improves the internal pipe cleanliness, surface hardness, smoothness, and contaminant repulsion thereby reducing the effects of these pipe characteristics on the meter readings. The present invention therefore substantially improves flow meter reliability. Further, the present invention helps prevent catastrophic failures by minimizing erosion of fluid flow measurement system components.

Electroless plating is a process of metal deposition via a controlled chemical process. In contrast to electroplating, electroless plating requires no external source of current. Electroless plating involves a bath that utilizes a chemical reducing agent within the bath that provides a continuous buildup of deposits and imparts treated parts with contaminant repelling characteristics. This process allows parts to be evenly and consistently plated without respect to the geometry of the part. Deep bores, holes, sharp corners and complicated geometry can all be electroless plated without altering the finished geometry. The process also allows these features to be plated uniformly and as densely as preferred.

In at least one embodiment, the electroless plating process of the present invention comprises the deposition of nickel or a nickel-phosphorous alloy onto the surfaces of metal components by a chemical bath. The bath temperature and pH can vary between different electroless processes, though it is desirable to keep them constant during the electroless plating of a particular work piece. This set of conditions may be, for example, a bath temperature of about 200° F. at a pH of about 5.0. The plating thickness of the present invention is determined by the length of time it is immersed in the bath and may vary over a range of several microns, for example, from about 1 to about 250 microns. Further, the electroless plating may be hardened by heat treating. The temperature of heat treating may be between 200° F. and 1100° F., for example between 200° F. and 250° F. A further example is a plating thickness of about 250 microns, which may be hardened from about 400 to about 900 Vickers Hardness by heat treating at about 205° F. for about 1 hour.

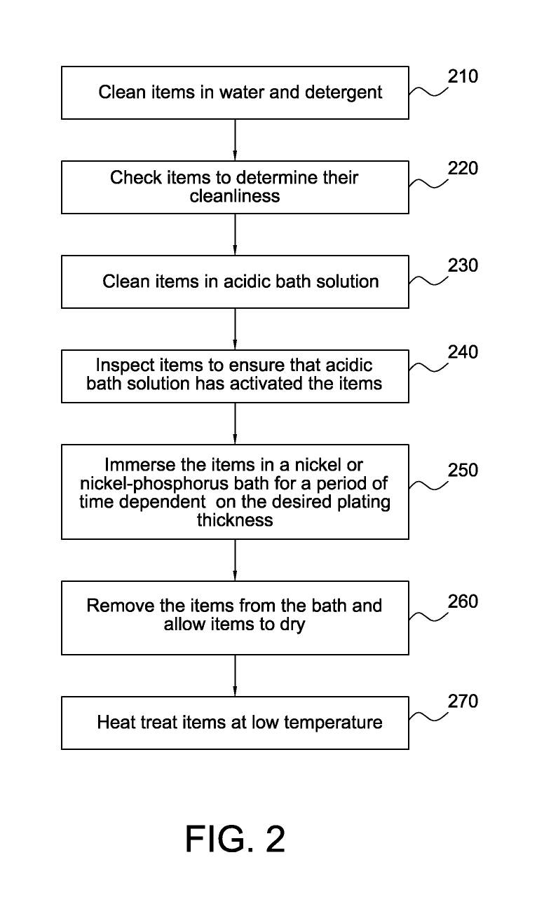

FIG. 2 outlines a brief overview of a non-limiting example of the electroless plating process according to an embodiment of the present invention. At 210, items are cleaned in water and detergent to remove oil, dirt, and other contaminants. At 220, the items are checked to determine their cleanliness, for example, by visual inspection. The process may need to return to 210 and the items cleaned and checked again until an acceptable contamination level is achieved. When the no contamination can be detected during inspection, the items are dried. At 230, the items to be plated are cleaned in an acidic bath of predetermined properties, for example, a temperature of about 100° F. and a pH of about 2.0. At 240, the items are inspected, e.g., visually, to make sure the acidic solution has activated the material.

When activation is verified, the items are immersed in a nickel or nickel-phosphorous bath at 250. The time the items are kept in the bath depends on the rate of plating deposition and the desired plating thickness. For example, the rate of deposition for a typical electroless nickel bath may be from about 0.1 to about 1.2 mils/hr. At 260, the items are removed from the bath and allowed to dry. At 270, the items are heat treated at low temperature to remove dissolved gasses from the plating. The items may be further heat treated at a higher temperature to increase the hardness of the plating.

The bath comprises a soluble nickel, a reducing agent, a pH buffer, and a solvent. The bath may also optionally include a complexing agent and stabilizers. The soluble nickel may be, for example, nickel sulfate. The reducing agent may be, for example, sodium hypophosphite. The pH buffer may be, for example, ammonium hydroxide. The solvent may be, for example, water. A complexing agent such as a tartrate and stabilizers such as a lead salt may also be added to the bath. The ratio between the components can vary between different electroless nickel baths.

Electroless nickel plating occurs in three main steps including pretreatment, chemical bath, and heat treatment. There are a range of possible methods for accomplishing each step and the selected methods are typically chosen based on the sought after goals. As electroless plating is insensitive to part geometry, all items will be plated using a similar process. The entire piece can be electroless plated, including the outside of piping or meter bodies, without affecting the ability to paint or apply other platings. If desired, parts of the piece can be masked off to prevent plating from occurring on those parts, but this is unnecessary in the present invention.

An non-limiting example of the electroless nickel plating process in accordance with the present invention is as follows:
1. A first step is to soak the item (material to be plated) in a detergent that removes oils, dirt, dust, etc. from the surface of the metal. The item should be thoroughly cleaned as much as possible as contaminants can affect the deposition of the nickel coating. A visual inspection of the item is usually sufficient to determine if they has been cleaned appropriately.
2. The item is then immersed in a highly acidic bath, with the immersion time being dependent on the bath pH, and the material being treated. A highly acidic bath will require less time, but must be balanced with the ability of the item to survive strong acids. The bath temperature may also be used to balance the reactivity of the item with the acid. The purpose of the acid bath is to further clean the item of contaminants, and also remove the thin layer of oxidation that naturally forms on metallic substances when exposed to gases. A visual inspection of the item is sufficient to determine if the oxidation layer has been removed.
3. The item is removed from the acid bath and immediately immersed in a chemical bath. The item remains in the bath for a predetermined length of time, depending on bath composition, temperature, pH, and desired thickness.
4. The item is removed from the bath and baked at low temperature (below 200° C.) for a predetermined length of time to remove gas from the nickel coat. Further heat treatment may be performed at higher temperatures depending on the desired nickel hardness and ductility.

An non-limiting example of a set of properties of an electroless nickel bath in accordance with and suitable for use with the present invention is listed in the table below. The table lists the desired properties of the bath, including phosphorous content, melting point, density, hardness, ductility, plating thickness, wear resistance, corrosion resistance, frictional property, and magnetic property. The listed properties are for one suitable bath formulation and provided to enable the invention. Other suitable solutions having differing properties may be utilized according to the invention.

Example Electroless Nickel Bath Properties

| | |
|---|---|
| Phosphorous | 12 wt % |
| contents | |
| Melting Point | 900° C. |
| Density | 7.9 g/cm³ |
| Hardness | As plated: 400 VHN; Heat treated: 900 VHN |
| Ductility | 1.3% Elongation |
| Plating Thickness | 0.6 mils at 1 hour immersion |
| Wear Resistance | Taber Abrasion Test (ASTM D-4060) |
| | As plated: 9 mg/1000 cycles |
| | Heat treated: 3 mg/1000 cycles |
| Corrosion | <0.2 mil/year in Brine (3 wt % salt, |
| Resistance | CO₂ saturated) at 95° C.; |
| | <0.6 mil/year in 10 wt % hydrochloric |
| | acid at 20° C.; |
| | <0.2 mil/year in 65 wt % sulfuric acid at 20° C.; |
| Frictional Property | Coefficient of Friction (versus steel): |
| | 0.4 (dry) and 0.13 (lubricated) |
| Magnetic Property | Non-Magnetic |

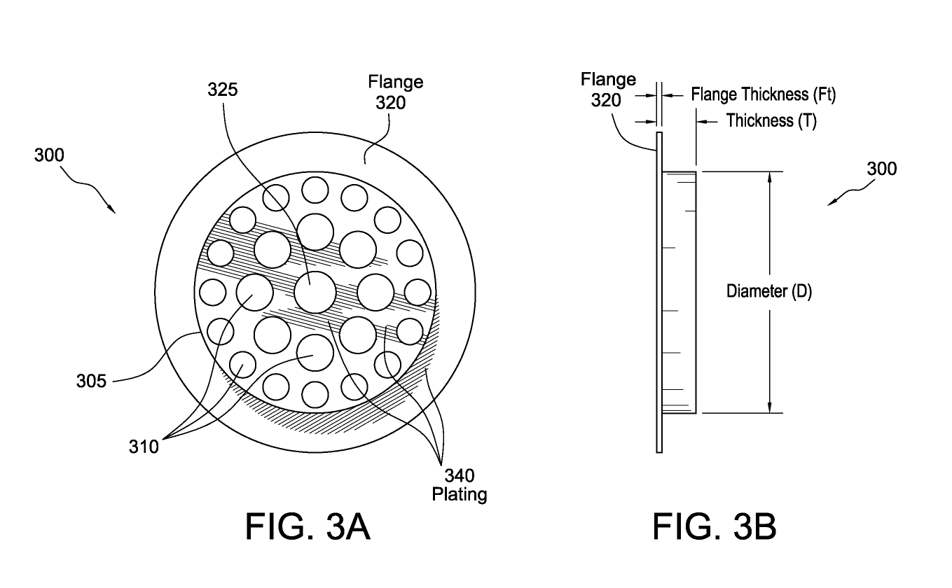

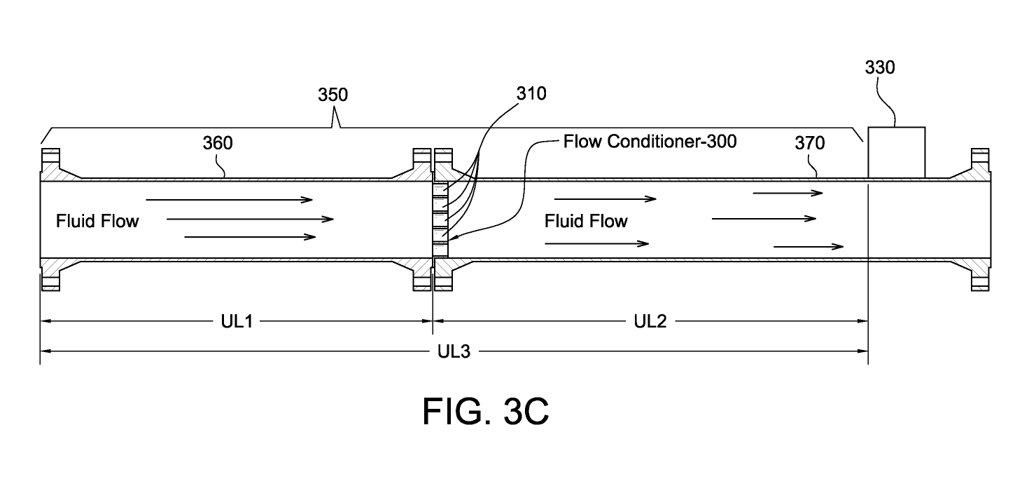

There are several flow conditioner designs employed with flow measurement systems. These flow conditioners typically comprise a circular plate or cylindrical body having an array of holes. FIGS. 3A-3B illustrate an exemplary embodiment of a flow conditioner in accordance with the present invention. The flow conditioner 300 includes a disk 305 having an array of through holes or apertures 310. In some embodiments, the apertures 310 are axially formed within the flow conditioner 300 in a radial array. The flow conditioner is designed to be placed orthogonally across the internal cross-section of a fluid flow pipe shown in FIG. 3C such that the apertures 310 are aligned axially with the pipe. The apertures 310 may be sized and arranged in a variety of patterns in order to impart a desired affect on a fluid flowing through the pipe.

In the embodiment illustrated in FIGS. 3A-3B, flow conditioner 300 includes a flange 320 which surrounds disk 305. Disk 305 may include a plurality of holes 310 arranged in two concentric rings with a central hole 325. Insertion-type disks that do not have a flange or raised face may also be used without departing from the invention. Other suitable flow conditioners include the CPA TBR, and the CPA 50E RTJ flow conditioners available from Canada Pipeline Accessories of Calgary, Alberta Canada; and the flow conditioners described in U.S. Pat. No. 5,341,848, which is herein incorporated by reference in its entirety.

In keeping with the invention, the flow conditioner 300 is provided with a thin layer of nickel plating 340 that is deposited on the entire surface of the flow conditioner 300 including the surface of the apertures 310 in accordance with the procedure described above.

In a specific embodiment, the nickel plating 340 may comprise between about 1% and about 13% phosphorus and between about 87% and about 99% nickel, by weight. The thickness of the plating 340 may be between about 1 and about 250 microns, for example between about 10 and about 50 microns, with a Vickers Hardness between about 850 and about 1100 after heat treatment. In one embodiment, the nickel phosphorous plating 340 may be about 12% phosphorous and about 88% nickel, by weight. The thickness of the plating 340 may be about 13 microns with Vickers hardness of about 900.

FIG. 3C illustrates a flow measurement system including a pipe assembly 350 and a flow meter 330 connected to the downstream end portion of the pipe assembly. Pipe assembly 350 includes one or more sections of pipe (UL1, UL2) and a flow conditioner 300 attached to the one or more sections of pipe.

In one embodiment, pipe assembly 350 includes a first section 360 and a second section 370 where flow conditioner 300 is disposed between the first section 360 and second section 370 so as to be downstream from section 360 and upstream from section 370. The first section has a pipe length UL1 and the second section has a pipe length UL2. Length UL1 defines a length of straight pipe disposed immediately upstream of the flow conditioner. Length UL2 defines a length of pipe measured from the flow conditioner to the flow meter. These lengths are determined through experimental testing, and are set at the minimum length needed to recreate a fully developed flow profile. The experimental data shows that in most types of installation, there is a length of UL1 and UL2 at which the errors due to velocity profile are eliminated. The total length of pipe encompassing UL1, the flow conditioner, UL2, the meter, and a downstream pipe spool is known as a meter run.

In keeping with the invention, one or more of the components of the pipe assembly may be plated with a nickel or nickel-phosphorous plating described herein. For example, in one embodiment, flow conditioner 300 and an interior surface of the first section of pipe 360 are provided with plating 340. In another embodiment, flow conditioner 300 and an interior surface of the second section of pipe 370 are provided with plating 340. In still another embodiment, an interior surface of the first section of pipe 360 and an interior surface of the second section of pipe 370 are provided with plating 340 and the flow conditioner 300 is not plated. In still a further embodiment, an interior surface of the first section of pipe 360 and an interior surface of the second section of pipe 370 and flow conditioner 300 are provided with plating 340.

The electroless nickel plated fluid flow system disclosed herein provides the system with many advantages. The electroless nickel plating applied to the fluid flow system components including the flow conditioner and sections of pipe, improves the wear resistance, abrasion resistance, alkali corrosion resistance, and acid resistance of the system. The electroless nickel plating also improves plating uniformity, improved plating density, and maintenance of the pretreatment surface finish. These improved properties allow the fluid flow system to avoid the buildup of deposits, thereby enabling sustained system metering accuracy and repeatability, and diminish the costs and problems associated with system maintenance.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

What is claimed is:

1. A flow conditioner, comprising:
a disk comprising a flange and an array of apertures formed in said disk, said apertures being sized and arranged to generate a flow profile in a fluid flow when placed within a fluid flow pipe in an orientation substantially perpendicular to the axis of the conduit; and
an electroless nickel plating deposited on the surface of said disk, wherein said plating is uniformly applied to cover the entire surface of the disk including walls of said apertures.

2. A flow conditioner according to claim 1, wherein said plating comprises between about 87 wt. % to about 99 wt. % nickel based on the weight of said plating.

3. A flow conditioner according to claim 2, wherein said plating further comprises between about 1 wt. % to about 13 wt. % phosphorous based on the weight of said plating.

4. A flow conditioner according to claim 1, wherein said plating comprises between about 12 wt. % phosphorus and about 88 wt. % nickel based on the weight of said plating.

5. A flow conditioner according to claim 1, wherein said plating has a thickness of about 1 to about 250 microns.

6. A flow conditioner according to claim 1, wherein said plating has a thickness of about 10 to about 50 microns.

7. A flow conditioner according to claim 1, wherein said plating has a Vickers hardness of about 850 to about 1100.

8. A flow conditioner according to claim 1, wherein said apertures comprise a plurality of holes arranged in two concentric rings around a center hole and the flange surrounds the disk.

9. A pipe assembly for flow measurement, comprising:
a fluid flow pipe;
a flow conditioner disposed within said fluid flow pipe in an orientation substantially perpendicular to an axis of said fluid flow pipe, said flow conditioner comprising:
a disk comprising a flange and an array of apertures formed in said disk, said apertures being sized and arranged to generate a specific flow profile in a fluid flow; and
an electroless nickel plating deposited on the surface of said disk, wherein said plating is uniformly applied to cover the entire surface of the device including the walls of said apertures.

10. A pipe assembly according to claim 9, wherein said plating comprises between about 87 wt. % to about 99 wt. % nickel based on the weight of said plating.

11. A pipe assembly according to claim 10, wherein said plating further comprises between about 1 wt. % to about 13 wt. % phosphorous based on the weight of said plating.

12. A pipe assembly according to claim 9, wherein said plating comprises between about 12 wt. % phosphorus and about 88 wt. % nickel based on the weight of said plating.

13. A pipe assembly according to claim 9, wherein said plating has a thickness of about 1 to about 250 microns.

14. A pipe assembly according to claim 9, wherein said plating has a thickness of about 10 to about 50 microns.

15. A pipe assembly according to claim 9, wherein said plating has a Vickers hardness of about 850 to about 1100.

16. A fluid flow measurement system, comprising:
a fluid flow pipe comprising at least one section having an electroless nickel plated coating on an interior surface of said pipe;
a flow conditioner disposed within said fluid flow pipe in an orientation substantially perpendicular to an axis of said fluid flow pipe, said flow conditioner comprising 1) a disk comprising an array of apertures formed in said disk, said apertures being sized and arranged to generate a specific fluid flow profile; and 2) an electroless nickel plated coating deposited on the surface of said disk; and
a flow meter downstream of the flow conditioner.

17. A fluid flow measurement system according to claim 16, wherein said electroless nickel plated coating deposited on the surface of said disk and/or the interior surface of said pipe comprises between about 12 wt. % phosphorus and about 88 wt. % nickel based on the weight of said coating and has a thickness of about 10 to about 50 microns.

18. A fluid flow measurement system according to claim 16, wherein the electroless nickel plated coating on an interior surface of said pipe is upstream of the flow conditioner.

19. A fluid flow measurement system according to claim 16, wherein the electroless nickel plated coating on an interior surface of said pipe is downstream of the flow conditioner.

20. A method for applying a coating to a flow conditioner, comprising:
cleaning a flow conditioner in an acidic bath;
removing the flow conditioner from the acidic bath;
immersing the flow conditioner in a nickel bath, thereby applying an electroless nickel plating to the flow conditioner including apertures of said flow conditioner; and
heating the plated flow conditioner to remove gas from the nickel plating, thereby inhibiting build up of contaminant deposits on the flow conditioner.

21. A method according to claim 20, comprising immersing the flow conditioner in a nickel-phosphorous bath, thereby applying an electroless nickel-phosphorous plating to the flow conditioner.

22. A method according to claim 20, further comprising hardening the flow conditioner via a heat treatment.
